(19) United States
(12) Patent Application Publication
(10) Pub. No.: US 2021/0209254 A1
(43) Pub. Date: Jul. 8, 2021

(54) RULE-BASED CONTROL OF COMMUNICATION DEVICES

(71) Applicant: TECHNOLOGIE INTELLIGENTE LLC, Forestville, MD (US)

(72) Inventors: William A. LIGGINS, Washington, DC (US); Clarence B. MCCOLLUM, West Bloomfield, MI (US); Alok Kumar TIWARI, Navi Mumbai (IN)

(73) Assignee: TECHNOLOGIE INTELLIGENTE LLC, Forestville, MD (US)

(21) Appl. No.: 17/211,423

(22) Filed: Mar. 24, 2021

Related U.S. Application Data
(63) Continuation-in-part of application No. 16/994,371, filed on Aug. 14, 2020, now abandoned.
Application No. 16/994,371 is a continuation of application No. 15/934,631, filed on Mar. 23, 2018, now Pat. No. 10,754,986.
(60) Provisional application No. 62/476,231, filed on Mar. 24, 2017.

(51) Int. Cl. G06F 21/62; G06F 9/451; G06F 21/60; G06F 9/54; H04L 12/58

(52) U.S. Cl. CPC G06F 21/6254; G06F 9/452; G06F 21/629; G06F 21/604; G06F 9/451; H04L 51/12; H04L 51/00; G06F 2221/2141; G06F 9/543

(57) ABSTRACT

A system for facilitating rule-based control of a communication device may receive a set of desired device parameters at a VFP configured in the system. The set of desired device parameters may be received from a VFD engine configured in the communication device. The set of desired device parameters may be processed at the VFP. Based on the set of desired device parameters, a plurality of rules may be generated through a rule engine configured in the VFP. The plurality of rules may be generated for the respective one or more profiles. The processor may facilitate rule-based control to the communication device by the user. The rule-based control may be facilitated through the VFP. The rule-based control may be based on the plurality of rules for the respective one or more profiles associated with respective secondary layered environment.

### PRIORITY

This application is a continuation-in-part of and claims priority to U.S. application Ser. No. 16/994,371 filed on Aug. 14, 2020, which is a continuation of U.S. application Ser. No. 15/934,631 filed on Mar. 23, 2018, now U.S. Pat. No. 10,754,986 issued on Aug. 25, 2020, which claims priority to U.S. Provisional Application No. 62/476,231 filed on Mar. 24, 2017.

### BACKGROUND

Mobile communication devices including for example, a smart phone, store a huge amount of information. The information may include, for example, a list of contacts, messages, media content, application and other data. A user of the device may require different extents of the data in different scenarios. For example, at a work place, the user may need only professional data and/or applications. In another example, while on vacation or at home, the user may desire to avoid work related communication. However, there may not be an alternative in present smart phones to perform some actions such as, for example, to control communication or access to data based on a user preference. Instead, the user may personally need to ensure blocking and unblocking communication which may be a tedious and time-consuming task.

Moreover, in another scenario, a user may be an owner of the device. Being the owner, the user may desire to withhold or hide certain data from a third party user due to confidentiality or privacy reasons. The third party user may include, for example, a child, a family member, a colleague or other users. The current mobile devices may provide a phone lock alternative, but may not be able to hide or mask data if the phone is unlocked. This may happen in a scenario, for example, wherein a colleague or family member may request a device owner to borrow a phone. The phone may be borrowed for making a call and in the process may have access to contents or the data on the phone. Thus, there may not be an alternative in present smart phones, for example, to segregate, display, or control only required data based on a user preference. The devices may thus lack convenience of usage and/or security in both discussed scenarios.

Another existing concern may be related to malware. A communication device may be prone to malicious software programs such as, for example, a virus, a spyware, Trojan horse, ransomware, wiper and other such malwares. The malware may pose a security threat in the usage of the communication device. For example, the malware may activate certain drivers or accessories such as a mic of the device or lead to other such unauthorized activities on the communication device, without the knowledge or awareness of the user.

### SUMMARY

An example embodiment of the present disclosure pertains to a system for facilitating rule-based control of a communication device. The system includes a processor, a memory and a virtual firewall platform (VFP). The memory may store a plurality of instructions, which when executed by the processor, may cause the processor to receive a set of desired device parameters at a VFP configured in the system. The set of desired device parameters may be received from a virtual firewall for device (VFD) engine configured in the communication device. The set of desired device parameters may pertain to respective one or more profiles associated with the communication device. The set of desired device parameters may vary for the respective one or more profiles in terms of what action each profile allows a user to perform on the communication device. The set of desired device parameters may also vary for how the communication device should perform when the respective one or more profiles are invoked. Each profile of the respective one or more profiles may be associated with a respective secondary layered environment. The secondary layered environment may have a different communication enable criteria and a different application criteria. The set of desired device parameters may be processed at the VFP. Based on the set of desired device parameters, a plurality of rules may be generated through a rule engine configured in the VFP. The plurality of rules may be generated for the respective one or more profiles. The plurality of rules may be for the respective one or more profiles and the corresponding secondary layered environment. The plurality of rules may enable the VFD engine to monitor and control at least one of actions performed by the user on the communication device and settings of the communication device. The processor may facilitate rule-based control to the communication device by the user. The rule-based control may be facilitated through the VFP. The rule-based control may be based on the plurality of rules for the respective one or more profiles associated with respective secondary layered environment. The VFD engine may be operatively coupled to a media provider module that provides a media content to an application on the communication device through an application programming interface (API). The media provider module may interact with at least one of an external data source and a database management to obtain the media content. In an example embodiment, the external data source pertains to an external communication device.

Another embodiment of the present disclosure may include a communication device. The communication device may include a memory and a VFD engine. The memory may store a plurality of instructions. Upon execution of the plurality of instructions, the VFD engine may transmit a set of desired device parameters to a VFP configured in a server. The set of desired device parameters may be for respective one or more profiles associated with the communication device. The set of desired device parameters may vary for the respective one or more profiles in terms of what actions each profile allows a user to perform on the communication device or how the communication device should perform when the respective one or more profiles are invoked. Each profile of the respective one or more profiles may be associated with a respective secondary layered environment. The secondary layered environment has a different communication enable criteria and a different application criteria. The VFD engine may receive a plurality of rules from the VFP. The plurality of rules may be for the respective one or more profiles. The plurality of rules may be generated by the VFP based on processing of the set of desired device parameters. The plurality of rules for the respective one or more profiles and the corresponding secondary layered environment may enable the VFD engine to monitor and control at least one of actions performed by the user on the communication device and settings of the communication device. The VFD engine may process the plurality of rules for the respective one or more profiles associated with respective secondary layered environment. The VFD engine may process the plurality of rules to enable rule-based control to the communication device by the user.

Yet another embodiment of the present disclosure may include a method for facilitating rule-based control of a communication device. The method may include a step of receiving a set of desired device parameters at a VFP configured in a server. The set of desired device parameters may be received from a VFD engine configured in the communication device. The set of desired device parameters may be for respective one or more profiles associated with the communication device. The set of desired device parameters may vary for the respective one or more profiles in terms of what actions each profile allows a user to perform on the communication device or how the communication device should perform when the respective one or more profiles are invoked. Each profile of the respective one or more profiles may be associated with a respective secondary layered environment. The secondary layered environment may include a different communication enable criteria and a different application criteria. The method may include a step of processing the set of desired device parameters at the VFP. The processing may generate a plurality of rules for the respective one or more profiles through a rule engine configured in the VFP. The plurality of rules may be for the respective one or more profiles and the corresponding secondary layered environment. The plurality of rules may enable the VFD engine to monitor and control at least one of actions performed by the user on the communication device and settings of the communication device. The method may include a step of facilitating rule-based control to the communication device by the user. The rule-based control may be facilitated through the VFP. The rule-based control may be facilitated based on the plurality of rules for the respective one or more profiles associated with respective secondary layered environment.

### BRIEF DESCRIPTION OF DRAWINGS

FIG. 1 illustrates an overview of an interaction for facilitating rule-based control of a communication device, according to an example embodiment of the present disclosure.

FIG. 2 illustrates an overall architecture of a VFD engine associated a communication device, according to an example embodiment of the present disclosure.

FIG. 3A illustrates an exemplary overview for management of a media content by a VFD engine of FIG. 2, according to an example embodiment of the present disclosure.

FIG. 3B illustrates an exemplary overview for management of one or more messages by a VFD engine of FIG. 2, according to an example embodiment of the present disclosure.

FIG. 3C illustrates an exemplary overview for management of a communication device using a VFD engine of FIG. 2, according to an example embodiment of the present disclosure.

FIG. 3D illustrates an exemplary overview for management of one or more calls by a VFD engine of FIG. 2, according to an example embodiment of the present disclosure.

FIG. 4A illustrates an exemplary architecture of a VFP of FIG. 2, according to an example embodiment of the present disclosure.

FIG. 4B illustrates an exemplary overview of various profiles pertaining to a communication device of a user, according to an example embodiment of the present disclosure.

FIG. 4C illustrates an exemplary overview of steps for generating a profile, according to an example embodiment of the present disclosure.

FIGS. 5A through 5K, illustrate a screen on a VFD application showing one or more steps to be performed by a user on a communication device enabled by a VFD engine of FIG. 2, according to an example embodiment of the present disclosure.

FIGS. 6A through 6D illustrates an exemplary overview of a screen upon accessing an account on VFP of FIG. 1, according to an example embodiment of the present disclosure.

FIG. 7 illustrates an exemplary overview of an architecture of a VFP of FIG. 1, according to an example embodiment of the present disclosure.

FIG. 8 illustrates a hardware platform for the implementation of a system of FIG. 1, according to an example embodiment of the present disclosure.

FIG. 9 illustrates a process flowchart illustrating a method for facilitating rule-based control of a communication device, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered.

### Overview

Various embodiments describe a solution for facilitating rule-based control of a communication device. The rule-based control may allow a user to set and access respective one or more profiles on the communication device as per the requirement of the user. The respective one or more profiles may correspond to varying level of access provided to a user who may be an owner of the communication and/or a third party. The access may vary in terms of parameter, including, for example, incoming/outgoing calls, incoming/outgoing messages, device settings, media content and settings, and application content and settings and other such parameters. For example, a user may be at work and may require a work-related profile on the communication device for his personal usage. The profile may include only a set of allowed contacts or media content to be accessed. In another example, the user may require a profile that restricts certain information or media on the communication device to a third party upon access. The profile may be set based on any other such requirements for purpose of personal usage by the user including, for example, the owner of the communication device. The profile may also be set based on any such other requirements for purpose of security from a user who may be third party or from a malware attack. It may be appreciated that embodiments and concepts described herein may be applied in various other scenarios without departing from the scope of the teachings provided herein.

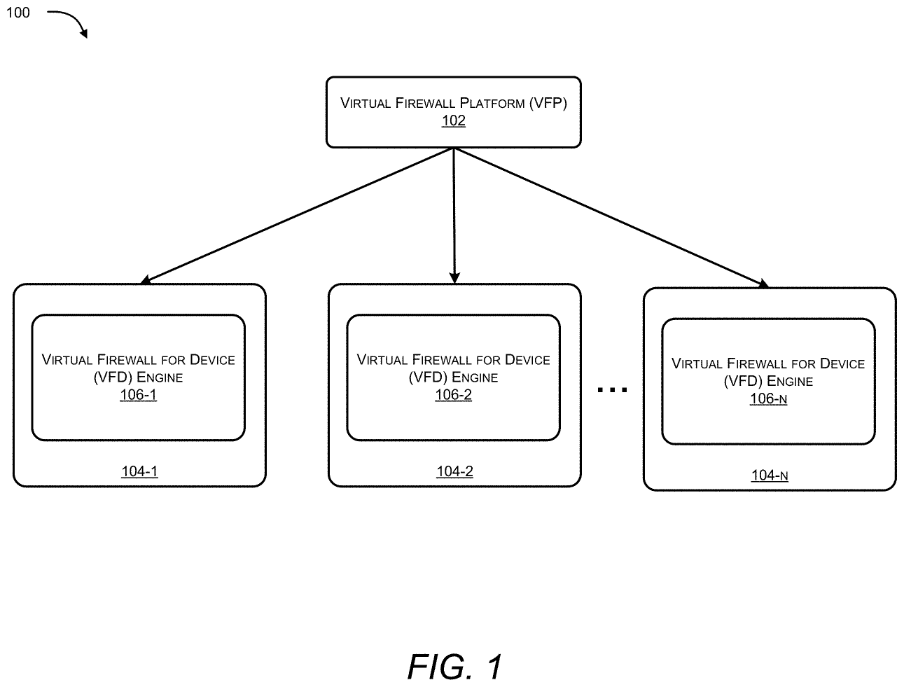

FIG. 1 illustrates an overview of a system 100 of a high-level interaction for facilitating rule-based control of a communication device, according to an example embodiment of the present disclosure. The system may be configured with a VFP 102. The VFP 102 may be communicably operable via a server. The VFP 102 may be a centralized system for facilitating rule-based control to one more communication devices (104-1, 104-2, . . . 104-N, hereinafter collectively referred to as 104). Each communication device 104 includes a VFD engine (106-1, 106-2, 106-N, hereinafter referred to as 106). Each communication device 104 may be associated with one or more users. The VFD engine 106 may transmit a set of desired device parameters to the VFP 102. The set of desired device parameters may pertain to respective one or more profiles associated with the communication device. The VFP 102 may process the set of desired device parameters to generate a plurality of rules through a rule engine configured in the VFP 102. The VFD engine 106 may receive the plurality of rules from the VFP 102. The plurality of rules may correspond to for respective one or more profiles. The VFD engine 106 processes the plurality of rules to enable rule-based control of the communication device by the user. Based on the plurality of rules, the VFD engine 106 may monitor and control at least one of actions performed by the user on the communication device and settings of the communication device. The actions may include, for example, at least one of incoming/outgoing calls, incoming/outgoing messages and a media content. The settings may include, for example, at least one of device settings, the settings pertaining to the media content, application content and settings. The respective one or more profiles may be associated with a respective secondary layered environment. The system may be implemented by way of a single device or a combination of multiple devices that are operatively connected or networked together. The system may be implemented in hardware or a suitable combination of hardware and software.

In an example embodiment, the user may include any of an owner of the communication device or a third party. The set of desired device parameters provided by VFD engine 106 may vary for the respective one or more profiles in terms of what action each profile allows a user to perform on the communication device. The set of desired device parameters may also vary for how the communication device should perform when the respective one or more profiles are invoked. Thus, the requirements of the rule-based control and hence the set of desired device parameters may vary with each profile and the purpose of usage of the user. In one example embodiment, the purpose of usage may be for private. In this case, the user may be an owner who may require to use the respective one or more profiles for private use. This may include scenarios, for example, a work based profile for accessing only work related aspects. The work related aspects may include access to professional contacts, text messages, media content and other such information accessible via the communication device 104. Another example may include personal profile in which the user may desire to restrict work related interaction or content. The personal profile may give the owner/user an access to only personal information including, for example, personal text messages, media content and other such information. In another example embodiment, the purpose of implementing profile based access may be meant for a third party. The third party may be an individual or a group including, for example, a kid, a family member, a friend, a colleague and any other such individual accessing the communication device 104. For example, a user may be a child or a colleague, for whom the owner may desire restricted access of certain information, based on which the owner may generate a particular profile. The user may be able to obtain one or more such profiles pertaining to a single communication device 104 such that each profile may have varying rule-based control.

The rule-based control may be based on the plurality of rules for the respective one or more profiles associated with a respective secondary layered environment. The secondary layered environment includes a different communication enable criteria and a different application criteria. The different communication enable criteria may be a criterion set by a user for managing, for example, at least one of a call, a message, a device and a media content. The different application criteria may be a criterion set by a user for managing, for example, one or more applications on the communication device. The plurality of rules generated by the VFP 102 may enable the VFD engine 106 to monitor and control at least one of actions performed by the user on the communication device and settings of the communication device. Upon execution of the plurality of rules for a profile selected from the respective one or more profiles by the VFD engine 106 on the communication device 104, certain parameters are defined and configured. The parameters may include at least one of incoming/outgoing calls, incoming/outgoing messages, device settings, media content and settings, and application content and settings. Based on the parameters, an access may be provided and actions may be undertaken by the user. In an example embodiment, the plurality of rules are applied on at least one of defined contact lists, settings of the communication device, network specific activity, and level of access granted to the user. The user of the communication device may also be able to update the plurality of rules. Based on the update, the VFD engine may synchronize with the VFP to control and monitor actions performed on the communication device for the respective one or more profiles.

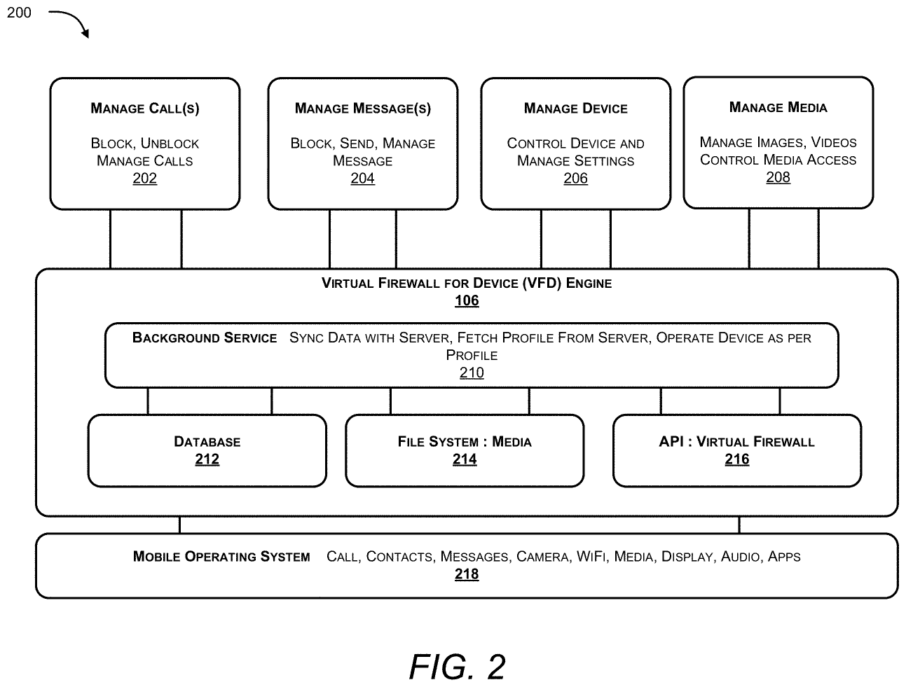

FIG. 2 illustrates an overall architecture 200 of the VFD engine 106 associated with the communication device 104, according to an example embodiment of the present disclosure. The VFD engine 106 may be a platform for a user to manage rule-based control for the respective one or more profiles. As illustrated in FIG. 2, and as per an example embodiment, the VFD engine 106 may enable a user to manage at least one of a call, a message, a media content and device settings. The user may be able to manage aspects corresponding to the profiles including, for example, managing calls 202, managing messages 204, managing media content 208, managing device settings 206 and other such aspects. In an example embodiment, the aspects may also be managed remotely by the user. The VFD engine 106 may access any or a combination of operating system (OS) parameters, messaging parameters, telephony parameters, and local file storage system parameters associated with the communication device. The VFD engine 106 includes a background service 210 to perform one or more actions. The actions may include at least one of syncing data with the server associated with the VFP 102, fetching a profile from the server, and operating the communication device 104 as per a profile of the respective one or more profiles. Information processed or fetched by the VFD engine 106 may be accessible to the user via a mobile application or a web-based browser. The user may be able to access device analytics including, for example, call history, message history, location history, browser history, apps details, media content and other such data on the communication device (interchangeably referred to as mobile operating system 218). The VFD engine 106 may be associated with a local database 212 configured in the communication device for storing/ enabling back up of local data associated with the communication device 104. The VFD engine 106 caches rule attributes in the local database 212. The rule attributes may be associated with the plurality of rules for the respective one or more profiles of the communication device 104. The VFD engine 106 may be able to store the messaging parameters and the telephony parameters related to a previously stored/generated profile in the local database 212. The VFD engine 106 may be able to access the operating system (OS) parameters including for example, the operating system level virtual firewall 216.

As illustrated in FIG. 2, the VFD engine 106 may be able to access one or more type of parameters of the communication device 104 including, for example, a call detail, a contact list, a message, a camera access, network (or WIFI) access, a media content, a display access, an audio access or a mobile application on the communication device 104 and other such parameters. The VFD engine 106 may be able to manage calls 202 that may relate to, for example, blocking a contact, unblocking a contact and other such actions pertaining to contact based attributes. Managing messages 204 may relate to, for example, blocking a message, unblocking a message, tagging a message as a private file and other such actions. The other actions may pertain to attributes of a text, a video message or an audio message. Managing the media content 208 may relate to, for example, tagging a media file as a private file, and/or managing an image, a video and other such content on the communication device 104 that may be required to be accessed depending on the content. Media files 214 may also be stored locally. Managing device settings 206 may relate to, for example control and/or management of a setting pertaining to the communication device 104.

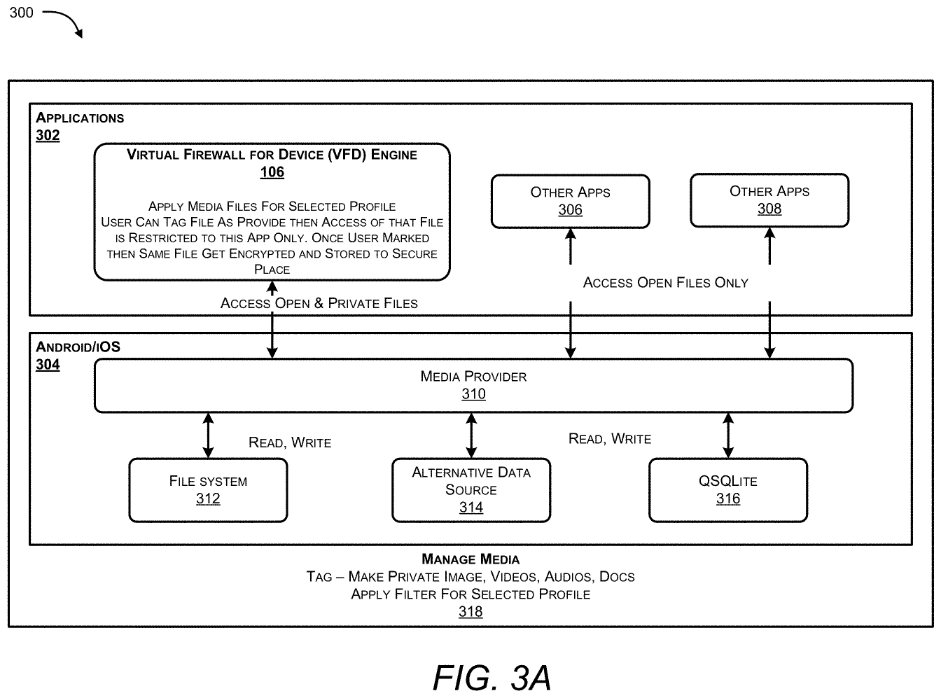

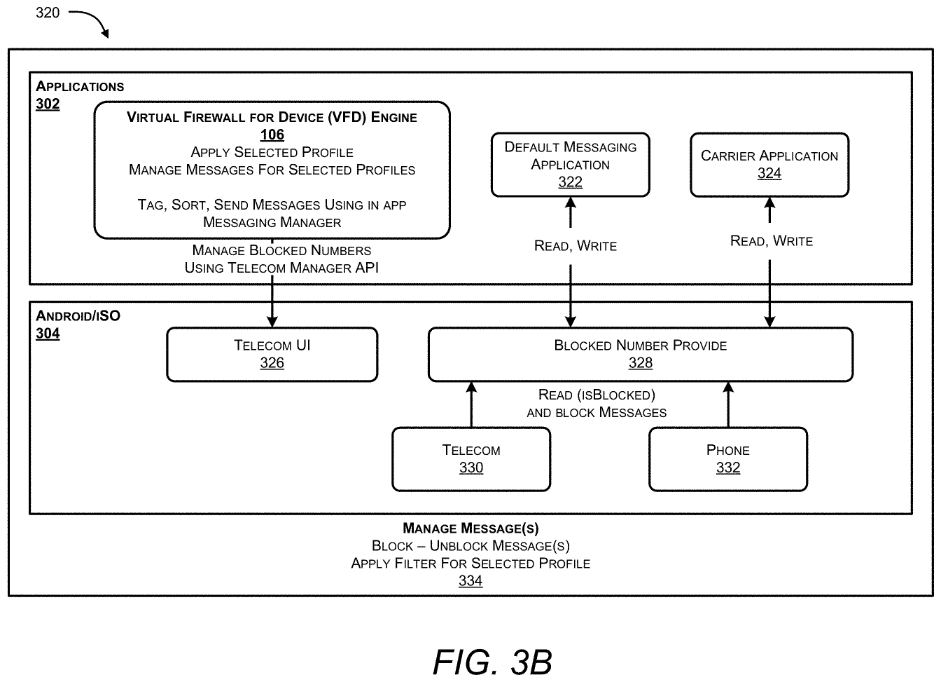

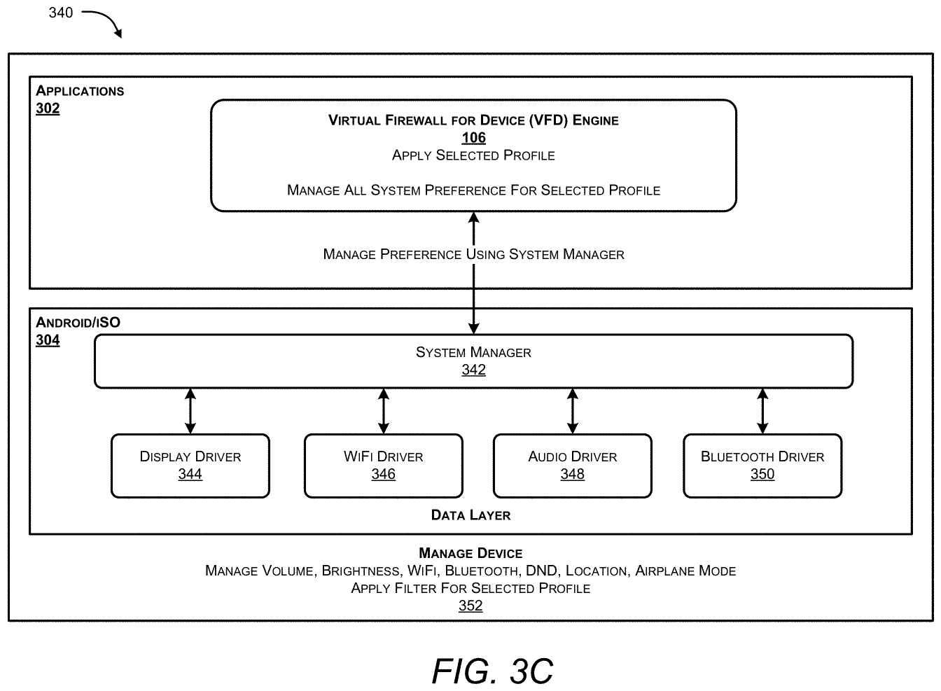

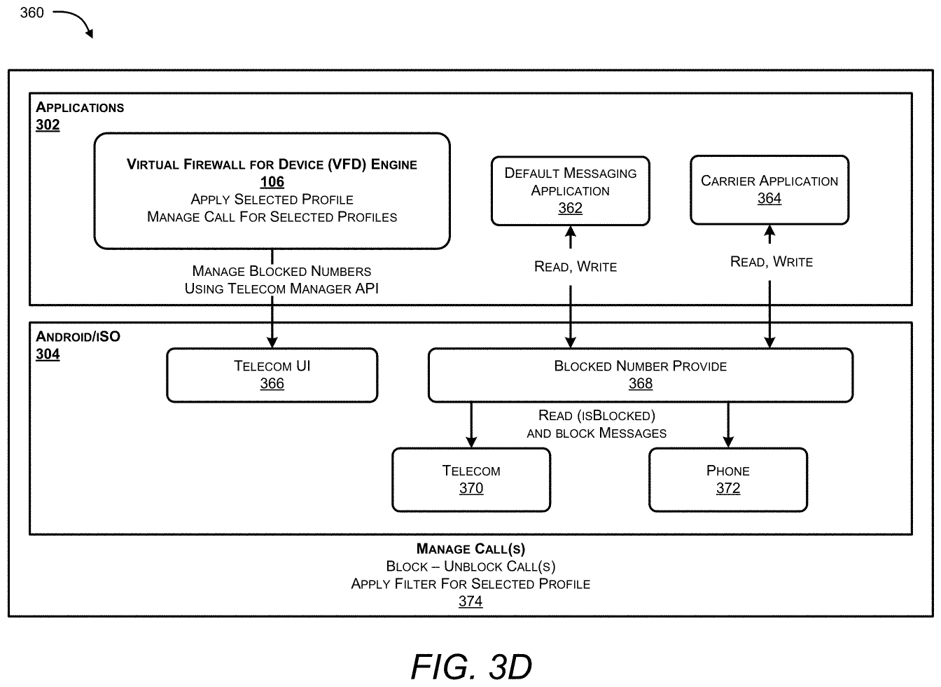

FIG. 3A illustrates an exemplary overview 300 for management of media content by the VFD engine 106 of FIG. 2, according to an example embodiment of the present disclosure. As illustrated, the VFD engine 106 may enable a user to manage a media content (318). The media content may include, for example, a video, an audio, a document and other such files. The VFD engine 106 may enable a filter for a selected profile. The filter may allow some profiles to have relatively more access to the media content than other profiles. The VFD engine 106 may interact with a media provider module 310 associated with the communication device. The media provider module 310 may optimize an indexed metadata information pertaining to at least one of an audio, a video, and an image. The indexed metadata information may be from at least one of a SD card and an internal memory. The media provider module 310 makes the media content available to an application on the communication device through public application programming interfaces (APIs). The applications may be able to access media files through the media provider module 310 from a file system 312. The mobile applications may also be able to access media files through a storage system. The mobile applications may get a uniform resource identifier (URI) of a particular file. The URI may be a component containing file information including, for example, a file size, a file path, a file type and the other such information. The media provider module 310 may also interact with alternative data source 314 such as other communication devices or other such devices to obtain the media content. The media provider module 310 may also interact with a QSQLite 316 for database management. The VFD engine 106 may enable a user to access and select one or more media files. The VFD engine 106 may apply media files for a selected profile based on a user preference. In an example embodiment, the VFD engine 106 may enable a user to manage the media content (318) by applying a filter to selected media content. In an example embodiment, the VFD engine 106 may enable a user to manage media content (318) by allowing to tag a media file as private. Post-tagging, access of the file may be restricted by encrypting the file with a secret key and storing the file to a particular location. The access may require authorization by using the secret key. The secret key may be permanent or temporary. In an example embodiment, after registration of a user, the system may generate a permanent secret key using a one way hashing algorithm. Using the generated permanent secret key as per profile rules, selective files may get encrypted or decrypted. In another example embodiment, the secret key may be generated for one-time usage. In an example embodiment, an access to media content may be based on profile rule such that if any particular file is protected or marked as private then the user may be able to access that file with the firewall application only by using a secret key assigned or known to the user. In this example, other applications that may not have access to the particular file because it may be completely hidden from other applications and may not be accessible in any other manner. In an example embodiment, a tagged file in one profile may be accessed in another profile if the device owner has the secret key and if the profile rules allow the two profiles to have access to the same tag. In an example embodiment, the secret key may be alphanumeric characters. The VFD engine 106 may enable public files to remain available for other applications such as 306 and 308. In an example embodiment, a general profile may be used such that if the device owner may wish to access all files then the user may be able to change the profile to general profile. In an example embodiment, a user may be able to provide a predefined or custom tag. The tag may include labels such as, for example, “Family”, “Personal” and other such tags. A tag may be defined as a relevant or a meaningful name for a group of files based on the type/category of the files. It may be possible to create multiple tags such that the users may get an option to add files under a particular tag. The media content such as images may be automatically tagged using an AI engine. The automated tagging may be performed by a recognition such as, for example, a facial recognition based on which selective media content may be excluded from a selected profile. The facial recognition may be performed using a machine learning library used primarily for applications such as computer vision and natural language processing. In an example embodiment, the facial recognition may be performed using Pytorch. As an example, a person “A” may wish to allow access only to images related to themselves but not of a family member “B”. In this case, based on automated facial recognition, any solo image or a group image pertaining to the member “B” may be automatically filtered out. In an example embodiment, a VFD application may be able to maintain metadata of media files, such that all filter operations may apply on the metadata. Based on the filter operation via metadata, the VFD application may display media content in a pagination format i.e. content may be divided and represented in an organized manner, which depends on the plurality of rules pertaining to a profile. In an example embodiment, a device owner or a user may be able to apply filter on a huge volume of media files based on the computational power or processing ability of the system, wherein tagging may reduce the need for re-processing or re-filtering of files due to grouping of the files.

FIG. 3B illustrates an exemplary overview 320 for management of one or more messages by the VFD engine 106 of FIG. 2, according to an example embodiment of the present disclosure. The communication device may include an application interface 302 including the VFD engine 106 and an operating system 304. As illustrated, the VFD engine 106 may enable a user to manage an activity 334 pertaining to a message associated with the respective one or more profiles. The activity may include, for example, tagging, sorting, blocking, unblocking, and sending the message, which may be performed by the user using an application messaging manager feature. In an example embodiment, the VFD engine 106 may enable a user to manage message files for selected profile based on user's preference. In an example embodiment, the VFD engine 106 may enable a user to tag a message as private. Post-tagging, access to the message may be allowed only upon authorization. The VFD engine 106 may enable application of a filter for selected profile. For example, some profiles may have access to receiving messages from a certain contact. In case of another profile the message from the contact may be blocked. The filter may also be applied to allow selected profiles to access blocked messages and disallow other profiles from accessing the already blocked messages. This operation may enable a user to avoid interactions from undesired individuals. In case of a third party being a user, this implementation may also enable to restrict confidential text from being read by the third party user. In an example embodiment, the present configuration allows a user to store/retain a list of blocked contacts. The blocked contacts may be a list of contacts from whom any received messages may be required to be blocked. In some example embodiments, the list of contacts may be stored/retained even upon switching apps or changing the communication device. The list of blocked contacts may be shared by one or more relevant apps on the communication device to streamline the list.

As illustrated in FIG. 3B, the VFD engine 106 interacts with a telecom user interface (UI) (326) on the operating system 304 to manage the list of blocked contacts. In an example embodiment, a user can create the respective one or more profiles using the VFD engine 106, wherein each profile may have a rule-based control to block messages. The user can block/unblock contacts or update a list of blocked contacts using the VFD engine 106, accessible by an application on the communication device or web browsing. The communication device may include a blocked number provider 328 to retrieve a list of commonly blocked contacts, such as, for example spam messages and content. A telecom 330 and phone 332 may read the list of blocked contacts from the blocked number provider 328. The application interface 302 may include a default messaging application 322 and a carrier application 324 to read and write an operation pertaining to blocked contacts using the blocked number provider 328.

FIG. 3C illustrates an exemplary overview 340 for management of a communication device using the VFD engine 106 of FIG. 2, according to an example embodiment of the present disclosure. Using the VFD engine 106, a user may be able to manage one or more device settings or device preferences (interchangeably referred to as manage device 352) for a selected profile. The management of the communication device may enable the user to manage one or more parameters. The parameters may include, for example, managing volume, Bluetooth™ settings, display related settings, do-not-disturb (DND) settings, location settings, airplane mode and other such hardware based settings. The communication device may include an application interface 302 including the VFD engine 106 and an operating system 304. The management of the communication device is enabled by inter-communication between multiple components including, for example, the application interface 302, a kernel, a library and an application framework. The library may pertain to at least one of an open-source web browser engine WebKit, SQLite database for storage and sharing of application data, a library to play and record audio and video and a SSL library responsible for Internet security. The application framework layer may provide many higher-level services to applications, which are present at the top layer and enable writing of an application.

The VFD engine 106 may enable reading processed plurality of rules received from VFP and passing the rules to a system manager 342 associated within the application framework/operating system. Each received plurality of rules is parsed into firmware commands to control device hardware settings including, for example, volume settings, Bluetooth™ settings and other such settings. Based on the commands, the kernel may operate hardware component using one or more device drivers including, for example, a display driver 344 for management of display settings, a wifi driver 346 for management of wifi settings, an audio driver 348 for management of audio settings, a Bluetooth™ driver 350 for management of Bluetooth™ settings and other such drivers.

FIG. 3D illustrates an exemplary overview 360 for management of one or more calls by the VFD engine 106 of FIG. 2, according to an example embodiment of the present disclosure. The communication device may include an operating system 304 and an application interface 302 including the VFD engine 106. As illustrated, the VFD engine 106 may enable a user to manage an activity pertaining to a call (374) associated with one or more profiles. The activity may include, for example, tagging, sorting, blocking a contact, unblocking a contact, making calls and other such activities, which may be performed by the user using a telecom manager API provided within the application interface. The VFD engine 106 may enable calls for selected contact with respect to a selected profile. For example, some profiles may have access to receiving calls from a certain contact, whereas in case of another profile, any call from that contact may be blocked. A filter may also be applied to allow some selected profiles to access and implement blocked contacts. This operation may enable a user to avoid interactions based on the profile requirements. In an example embodiment, the present configuration allows a user to store/retain a list of blocked contacts. The blocked contacts may be a list of contacts from whom any incoming calls may be required to be blocked. In some example embodiments, the list of contacts may be stored/retained even upon switching apps or changing the communication device. The list of blocked contacts may be shared by multiple relevant applications on the communication device to streamline the list. In case of a third party being a user, this implementation may restrict, for example, a third party person from making call using the communication device.

As illustrated in FIG. 3D, the VFD engine 106 interacts with a telecom UI (366) on the operating system 304 to manage the list of blocked contacts. In an example embodiment, a user can create the respective one or more profiles using the VFD engine 106, wherein each profile may have a rule-based control to block calls. The user can block/unblock contacts or update a list of blocked contacts using the VFD engine 106, accessible by an application on the communication device or web browsing. The communication device may include a blocked number provider 368 to retrieve a list of commonly blocked contacts, such as, for example spam calls. A telecom 370 and phone 372 may read the list of blocked contacts from the blocked number provider 368. The application interface 302 may include a default messaging application 362 and a carrier application 364 to read and write an operation pertaining to blocked contacts using the blocked number provider 368.

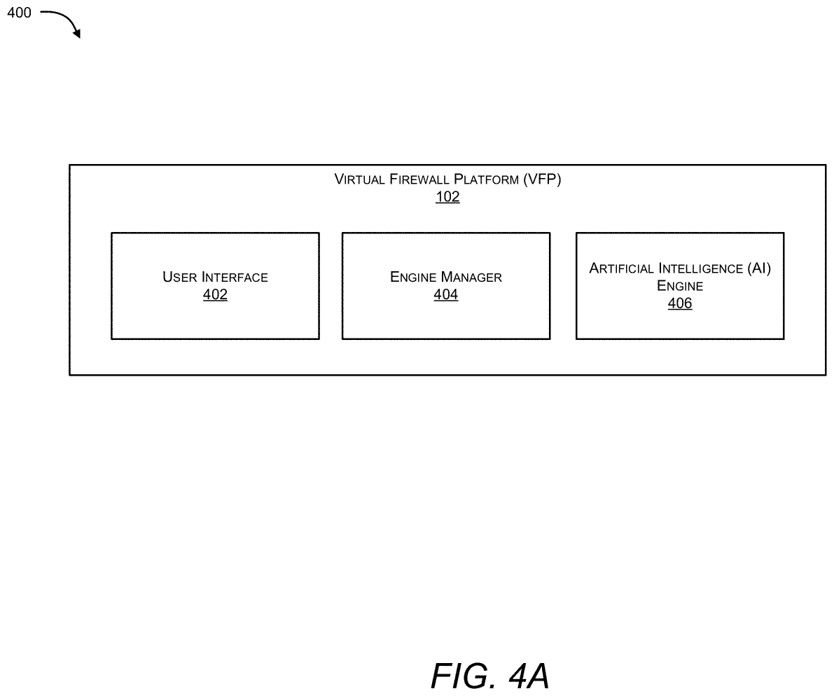

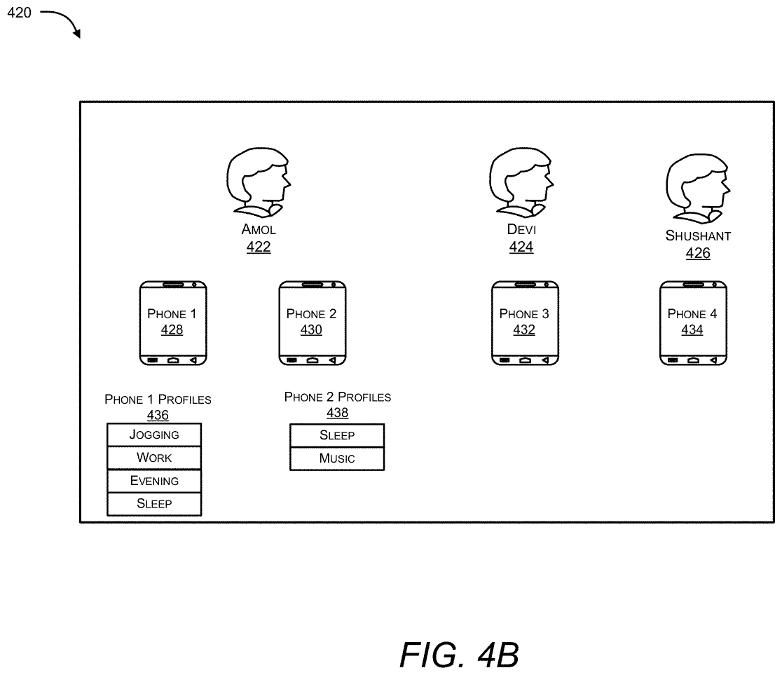

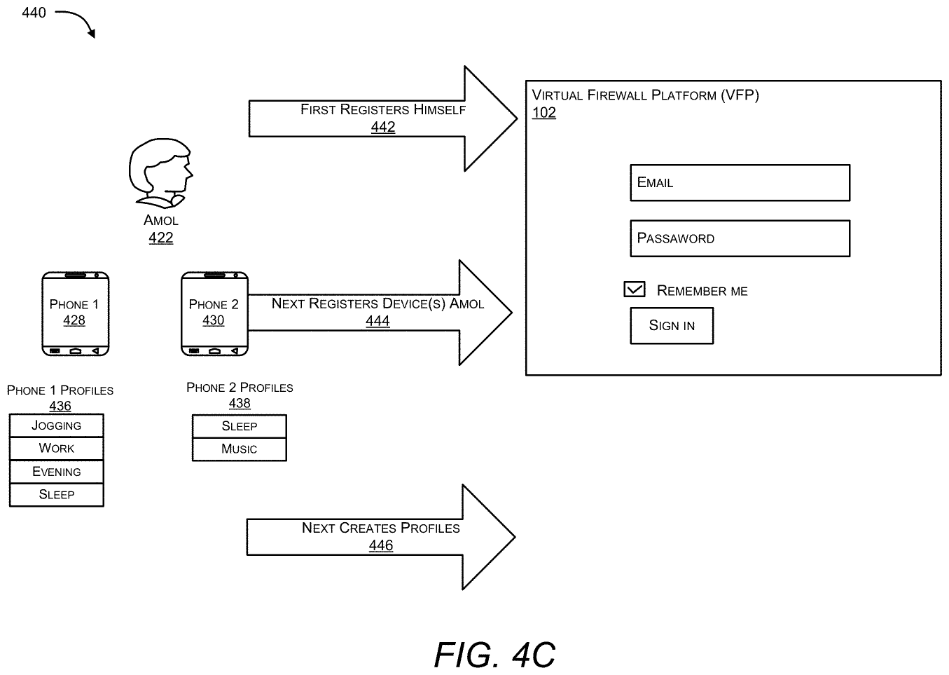

FIG. 4A illustrates an exemplary architecture 400 of the VFP 102 of FIG. 2, according to an example embodiment of the present disclosure. The VFP 102 includes a user interface 402, an engine manager 404 and an artificial intelligence (AI) engine 406. The user interface 402 may enable to receive the set of desired device parameters from the VFD engine 106 of the communication device. The engine manager 404 may enable communication between a rule engine of the VFP 102 and the AI engine 406. In an example embodiment, the plurality of rules may be triggered based on any or a combination of time, location, and triggers generated through the AI engine 404. For example, the system may be configured to switch a profile based on user preferences pertaining to a time or a location that may be most suitable for a particular profile. For example, the system may be configured to switch a profile based on a particular pattern of user preferences that may be detected by the AI engine 404 over a period of time. The processor of VFP 102 may interact with the rule engine and the AI engine 404 to generate the plurality of rules for a profile and a corresponding secondary layered environment. The VFD engine 106 may enable rule-based control of the communication device based on the plurality of rules received from the VFP. In an example embodiment, any unknown user may attempt to access using a mode of authentication such as, for example, using biometric authentication. Upon detecting failure of the authentication for a pre-defined number of attempts, the device may switch profile to default profile having limited access. The AI engine may also perform continuous monitoring of activity pertaining to a user based on location. Upon automated detection of a particular location, the AI engine may recommend or switch to a particular profile that may be set based on the location. For example, upon detecting change in location from home to office, the profile may automatically switch or a recommendation may be made to change the profile to the “office” profile that may include limited work related access based on requirements of the user.

FIG. 4B illustrates an exemplary overview 420 of various profiles pertaining to a communication device of a user, according to an example embodiment of the present disclosure. In an example, a single user such as Amol (422) may be associated with multiple communication devices (428, 430). In another example, a single user such as Devi (424) or Shushant (426) may be associated with independent communication devices 432 and 434 respectively. Each communication device (such as 428) may be associated with multiple profiles 436. For example, a “Jogging” profile may be configured such that it provide access to the user 422 towards applications related to, for example, health, running, meditation, music and other such applications only. In another example, the jogging profile may be configured to block all work and personal calls/messages to enable the user to focus on the activity only. As another example, on the same communication device (such as 428), a user may select “work” profile. The work profile may block all personal messages, calls, media content and other such personal content. In this example, the user 422 may require to access only work related content to avoid being disturbed by personal calls/messages. In another aspect of the same example, the user 422 and user 424 may be work colleagues. The user 424 may switch on the “work” profile on the communication device 422. If the communication device 428 is to be accessed by the user 424 (i.e. third party), a private/personal content on the communication device may not be accessible to the user 424.

In an example embodiment, the profiles may not be configured by only location or activity but may also be set by duration of the day such as “evening” and “sleep”. Several other such profiles may be configured based on the preference or requirements of the user. The user may switch between the profiles when required. In an embodiment, it may be possible to auto-set triggers such that based on the set trigger, the communication device may automatically switch to a specific profile. In an example embodiment, the switching of profiles may require authentication. In another example embodiment, the switching of profiles may be done only if the user is an owner of the communication device. In an example embodiment, it may be possible that the user such as 422 creates a profile for one communication device such as 436. The same profile may be possible to be configured on another communication device 438. In another example embodiment, the user 422 may be able to configure separate set of profiles on separate communication devices that belong to the user (such as 428 and 430).

FIG. 4C illustrates an exemplary overview 440 of steps for generating a profile, according to an example embodiment of the present disclosure. The user (such as Amol) 422 may own multiple communication devices such as 428 and 430. The user 422 may sign up for accessing the VFP 102, if the user is a first time user and does not have an activated account. In an example embodiment, the user may be able to create one or multiple accounts. The user may be able to sign up using a web browser or an application on the communication device (428 and/or 430). In an example embodiment, the user may select one or more packages for registration including, for example, a free package, a basic package, a premium package and other such packages. Based on the selected package, the user may get access of various segments, for example, view analytics, number of communication devices, number of profiles, and other existing options. The user 422 may register himself at 442 to set/obtain a login credential (such as email ID or password). Upon providing the login credential, the user 422 may register one or more communication devices (428 and 430) at 444 associated with the user. Each registered communication device may need to download and install a VFD application for interfacing interaction of the VFP 102 with VFD engine 106 of the communication devices (428, 430). Using a VFD application interface, the user 422 may also be able to create the respective one or more profiles (436, 438) at step 446.

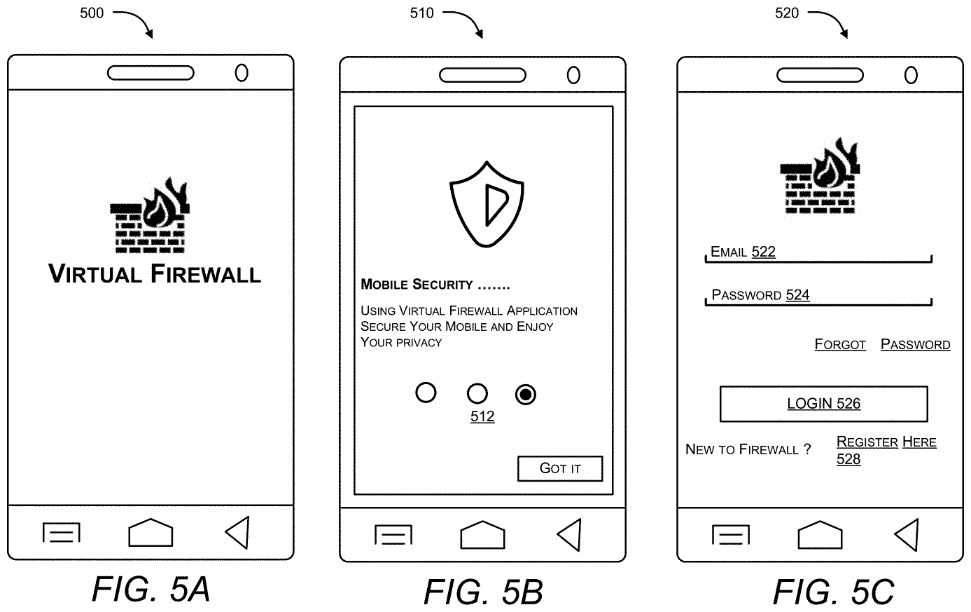

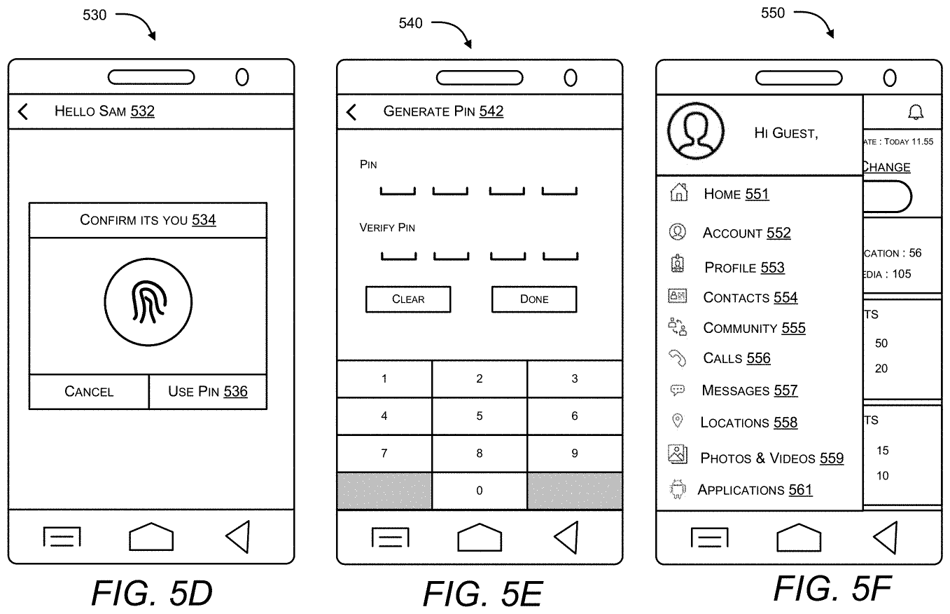

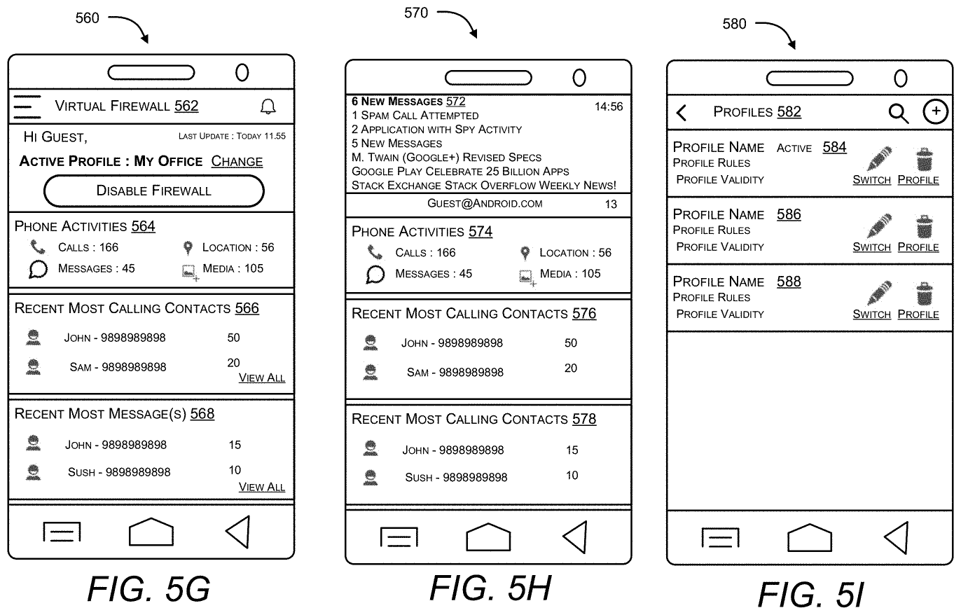

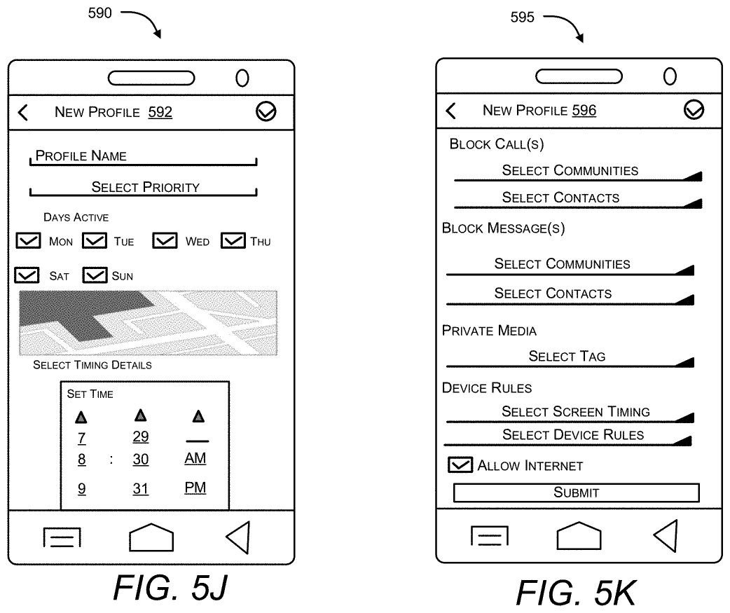

FIGS. 5A through 5K, illustrate a screen on the VFD application showing one or more steps to be performed by a user on a communication device enabled by VFD engine 106 of FIG. 2, according to an example embodiment of the present disclosure. In an example embodiment, each registered communication device may need to download and install a VFD application for interfacing interaction of the VFP 102 with the corresponding VFD engine 106. FIG. 5A illustrates an exemplary overview 500 of VFD application interface screen upon installation on a communication device, according to an example embodiment of the present disclosure. In an example embodiment, the system may request one or more steps for registering authentication of a user to ensure security of usage. For example, such authentication may include requesting for at least one of a biometric, pin based or passcode authentication. Other modes of authentication are also possible. In an example embodiment, the authentication details may be pre-stored in a local database of the communication device for future use. The future use may include each access to the VFD application, profile switching activity, firewall enabling or disabling operations and other such activities that may enhance the security of usage for an owner of the communication device. FIGS. 5A through 5D illustrates an exemplary overview 510, 520, 530 and 540 related to authentication based access to a VFD application interface, according to an example embodiment of the present disclosure. As shown at 510 in FIG. 5B, the VFD application may require a mobile pin authentication 512, which may only be known to an owner of the communication device. As shown at 510 in FIG. 5C, the VFD application may require a login credential such as email ID 522 and password 524, based on which a login 526 may be enabled. A new user may have an option to register newly 528. As shown at 530 in FIG. 5C, the VFD application may require bio-metric authentication, such as, for example, a fingerprint based authentication. For example, the screen may include a portion (534) wherein a user 532 may be required to place his thumb or finger for enabling authentication. A user 532 may also be provided a choice to cancel the selection or alternatively use a pin authentication 536, which may only be known to an owner of the communication device. Other modes of biometric authentication may also be used. As shown at 540 in FIG. 5E, the VFD application may require a pin based authentication 542. This may require a user to enter a pin code along with a verification of the pin code. The examples as illustrated in these figures are exemplary in nature and several such authentication modes or their combination may be employed.

Upon successful authentication, a user may be able to access a list of existing profiles and other settings control tabs. Using the VFD application interface, the user may also be able to perform at least one activity. The activity may include, for example, a creation of the respective one or more profiles and operational control to change one or more settings. FIG. 5F illustrates a screen 550 upon successful authentication on the VFD application, according to an example embodiment of the present disclosure. The screen displays several options such as home button 551, account access 552, profile access 553, contacts access 554, community 555, calls 556, access to messages 557, locations 558, photos and videos 559 and applications 561. The VFD application interface may also include access to various activities performed in an active profile. FIG. 5G illustrates a screen 560 showing one or more activity status pertaining to an active profile, according to an example embodiment of the present disclosure. The screen 560 includes access to virtual firewall application 562 and an option to disable the firewall. The screen 560 also indicates an active profile “my office” and an option to “change” the profile. The other information may include various details such as phone activities 564, recent most contacted numbers 566 and recent most messaged contacts 568. The mentioned list can also enable to keep a track of the contacts whom a user has contacted the most. FIG. 5H illustrates a screen 570 showing one or more activity status pertaining to an active profile, according to an example embodiment of the present disclosure. The screen 570 shows a section 572 showing updates of new messages including the list of spam messages, application with spy activity and other aspects. The listing of spam messages and application with the spy activity may enable to block such contacts or application in the respective one or more profiles. The listing of spam messages may also prevent all unnecessary calls and messages after, for example, the user searches any content on the internet. The screen 570 further may show phone activities 574, calls 576 and messages 578 sent or received from various contacts.

FIG. 5I illustrates an exemplary overview 580 of existing profiles on a screen on a communication device, according to an example embodiment of the present disclosure. Upon accessing the VFD application interface, a user may be able to access respective one or more profiles (584, 586, 588) under a profiles section 582. The screen may also indicate an active profile 584 that may be in use. Each profile (584, 586, 588) may have an option to select “Switch” to be able to switch to the selected profile. Each profile may have an option to view the profile details by selecting “Profile”. Each profile may have a display of the corresponding rules to indicate a criteria corresponding to a profile. Each profile may have a display of the corresponding validity to indicate a time corresponding to validity of the profile or other validity details.

FIG. 5J through 5K illustrates an exemplary overview 590 and 595 showing generation of a new profile on a screen on a communication device, according to an example embodiment of the present disclosure. As shown in FIG. 5J, upon accessing the VFD application interface, a user may be able to create one or more new profiles (592). The screen may indicate that a new profile is to be created. The user may choose to add “Profile name” and “select priority” option. The selection of priority may render a selected profile as a prioritized profile. The user may also be able to select the number of active days in a week and a corresponding timing that a selected profile needs to be operably active. The settings may not be limited to this and calendar based option may also be used. In the calendar based option, a user may be able to indicate the dates between which a certain profile may be invoked. It may be appreciated that pre-selection of a day, a date or a time is only exemplary and the user may be able to switch to any profile or activate any profile at any point of time. As seen in FIG. 5K, the screen 595 shows a new profile 596 which may be in process of being created. The user may be able to manage calls by selecting call rules including, for example, blocking or unblocking a list of contacts or communities who can call and/or be called in the new profile 596 being created. The user may be able to manage messages by selecting message rules including, for example, blocking or unblocking a list of contacts or communities who can message and/or be messaged, sorting, tagging messages, auto reply to contact or communities, hide messages, delete messages, restore messages and other such alternatives in the new profile 596 being created. The user may be able to manage media content by selecting a media content to be tagged or restricted in the new profile 596 being created. Upon tagging, only authorization based access may be provided to the media content. The user may be able to for example, schedule operations deletion pertaining to the messages and/or the media content, as per mentioned frequency, restore the messages and/or media content from bin and perform other such operations. The user may also be able to choose communication device based rules to enable certain settings to be activated or deactivated in the new profile 596 being created. The communication device based rules may include, for example, managing volume, Bluetooth™ settings, display related settings, do-not-disturb (DND) settings, location settings, airplane mode and other such hardware based settings. The other options include the section of “screen timing” and option to allow an internet access. The screen timing option may be to get screen analytics such as, for example, number of hours that the device screen may be “on” or “off” state, mentioned time frame per profile that a screen may be active, and other such options. The internet access option may enable control of the internet access for mentioned time frame and/or set rules to enable/disable internet access for respective one or more profiles. Several other options may be selected. Once the options are chosen, the user may press a submit button to complete creation of the new profile 596.

Regarding management of calls, messages, emails and other such content, a user (device owner) may have the ability to perform one or more functionality using the VFD application interface. The user may be able to determine transmission of at least one of a phone call, a text message and an email, to and from the communication device. The user may be able to block calls and/or messages from at least one of a contact, an unknown contact, automated sales calls, live sales calls. The user may be able to set up filter to only allow certain numbers to contact by call and/or message at specific times. The user (device owner) may be able to select the information stored on the communication device to be made visible or invisible to any other users other than the device owner. The information may be at least one of call details, messages, media content, notes, passwords, application and other information.

Using the VFD engine 106, the user may be able to select a parameter as “favorite” and/or “prioritize” the same. For example, the user may be able to select items such as text messages, photos, and other items that are important and tag the items. The items may be transferred to a specific storage location in the VFD engine 106. Upon deletion of an entire message thread or photo album, the tagged items may not be deleted from the database of the VFD engine 106 until they are individually removed by a device owner. The user may be able to create a time span for retaining the tagged items. In an example embodiment, the items may be tagged by the system upon identification of certain keywords and phrases in plain English text. For example, “remember”, “don't forget to”, and other such phrase within a message may be added to prompt tagging. In an example embodiment, the VFD engine 106 may facilitate storing a set of phrases in the backend. In that case, if any text message may contain a phrase from the set of phrases, then the text message may be tagged as “important”. In an example embodiment, only a device owner may have exclusive access to the storage location of the tagged items. In an example embodiment, the device owner may have an ability to assign permission to grant other users with an access to the tagged items. The VFD engine 106 may enable a user to “sort” and “arrange” content, for example, messages, photos, emails, notes and other content by use of keywords. The keyword based access may be used for filing and quick access of similar content. In an example embodiment, the system and VFD engine 106 may include adaptive learning for sorting and filing as the device owner sets up the criterion for sorting. The system may learn and update the information related to one or more usual patterns of a user. Based on the learning, the system may suggest and recommend to a user. In an example embodiment, the adaptive learning may use an AI model that may be trained using a training dataset and a testing set to train the AI model based on critical words or key words. Prior to using, the datasets may be enriched by subjecting to pre-processing to remove all unnecessary terms such as for example, pronouns, articles, prepositions, numbers, single characters and other such terms. In an example embodiment, a Structured Query Language (SQL) database management may be used to store the model and/or datasets.

The VFD application may also enable a smart functionality based usage. In an example embodiment, upon creating a new profile, a user may be able to set rules based on time frame, specific location and other such aspects. The user may be able to add geo fencing for a selected profile from the respective one or more profiles with respect to a pre-determined location from a map. In an example embodiment, the geo-fencing may be performed at the time of creation of the selected profile. When the user may enter in the pre-determined location, the system may automatically apply or switched to the selected profile by geo-fencing In an example embodiment, an AI engine of the VFD engine 106 may monitor the communication device activity continuously and learn a user preference accordingly. Based on the learning, the AI engine suggest profile options. In an example embodiment, at least one of the plurality of rules are updated by the user of the communication device through the VFD engine 106. Based on this, the VFD engine 106 synchronizes with the VFP to control and monitor actions performed on the communication device for the respective one or more profiles. The VFD engine 106 may organize contacts based on most used or tagged information. In an example embodiment, a user may be able to set a time based note for a particular data for automatic deletion. The deletion may be temporary or permanent. The user may also have access to browser history and may be able to block specific websites in a profile.

In an example embodiment, a user (owner) may be able to mask the VFD application on a communication device. The masking may prevent a third party user from gaining knowledge about presence of the VFD application. In this scenario, the VFD application may be filtered out and the communication device may look like a normal device to avoid suspicion. This kind of smart filtering implementation may be useful especially for security application. In an example embodiment, upon installing the VFD application on the communication device, a launcher icon may facilitate launching the application to register or login into the application. By using authentication, for example, biometric authentication or passcode, a user may initiate the VFD application such that a background service may continuously work in the application background. The background service facilitates running the VFD application such that even if the VFD application may be in the foreground, background or killed state, the background service may be active and filtering data, thus providing effective masking of VFD application. In an example embodiment, a user i.e. a device owner may be able to activate VFD application via an authentication such as, for example, a biometric and a passcode authentication. If the VFD engine/application determines through biometric recognition that a third party user (user other than the owner) has the communication device, it may automatically activate “generic permissions”. The “generic permissions” may be designed by the device owner to show only the basic information on the communication device. In an example embodiment, a third party user may be provided permissions to specific “incoming & outgoing” communications.

In an example embodiment, the VFD engine 106 may be able to automatically detect a malicious software, for example, a spyware, malware or a cloning software that may be installed on a communication device. The VFD engine 106 may also be able to block the detected software. The VFD engine 106 may block the software from any attempts to access live calls, voice messages and other data transmissions to and from the communication device. The VFD engine 106 may block the software from any attempts to access any stored data on the communication device. By using application permissions and metadata, the VFD engine 106 may be able to analyze spyware activity and/or any theft of data. In an example embodiment, the activity may be analyzed or monitored by the AI engine of the VFP. In an example embodiment, information pertaining to a category or type of each downloaded application from a plurality of applications on the communication device may be pre-determined or stored. Based on the pre-determined category of each application, the VFD engine 106 may be able to monitor plurality of activities performed by the application and automatically detects a malicious application installed on a communication device. Based on the pre-determined category of each application, if a specific activity from a plurality of activities performed by each application is not related to the pre-determined category, the VFD engine detects an unusual pattern based on which an alert is flagged and notified to the user. In an example embodiment, the unusual pattern may include at least one of detection of activities including an activity pertaining to a location detection through a text message or one-time password, an activity pertaining to a media file in place of a text message, an activity pertaining to a contact list in place of a media file and an activity pertaining to a media file in place of a text message. Various other scenarios are possible. For example, an application “X” may be related to video/image editing and may deal only with media content corresponding to media files. If any unusual pattern is observed, such as, the application “X” attempting to access text message or one-time passwords (OTPs) in text messages, which is not relevant to the pre-determined category (i.e. media), then an alert may be flagged pertaining to unauthorized access. Thus, a user may be notified that the application “X” may be malicious. In another example, the same application “X” is considered related to video/image editing. If any unusual pattern is observed, such as, the application “X” may attempt to access location via text message or one-time passwords (OTPs), then conventional systems or techniques may not be able to detect any malicious activity as they may be limited to identifying location access only if it happens via Global Positioning System (GPS). However, the VFD engine 106 is able to identify that the location is being accessed by information in text messages, which is not relevant to the pre-determined category (i.e. media) of the application “X”. Based on this, an alert may be automatically flagged pertaining to unauthorized access and the user may be notified that the application may be malicious. In another example, an application “Y” may be related to text messaging and may deal only with text messages. Any unusual pattern may be observed, such as, if the application “Y” attempting to access media files or media content, which is not relevant to the pre-determined category (i.e. text messages). In this case, an alert may be flagged pertaining to unauthorized access and the user may be notified that the application “Y” may be malicious.

In an example embodiment, the VFD engine 106 may include a smart messenger feature. The feature may include scheduling when a message is sent and generating an alert for the sent message. The feature may allow a user to customize revert messages for different communities. For example, for a business community, the message may read as “I'm away from my desk, will be back later”. For example, for a family community, the message may read as “I'm taking the weekend off call my sister if you need anything”. The VFD engine 106 may allow a device owner to assign a “Point Person” for each communication community and grant filtering privileges of data to the selected person. This would allow the device owner to deny communications privileges from all other members in that environment but still remain connected by assigning only a primary person to engage within that community. The VFD engine 106 may enable connectivity with email services and calendar synchronization.

In an example embodiment, based on device movement and work timing, the VFD application may suggest breaks and generate alerts. Other possible functionalities of the VFD engine 106 may relate to screensaver management, health goal management alert, diet plans and corresponding notifications or reminders. Several other scenarios/features are possible within the scope of the present disclosure.

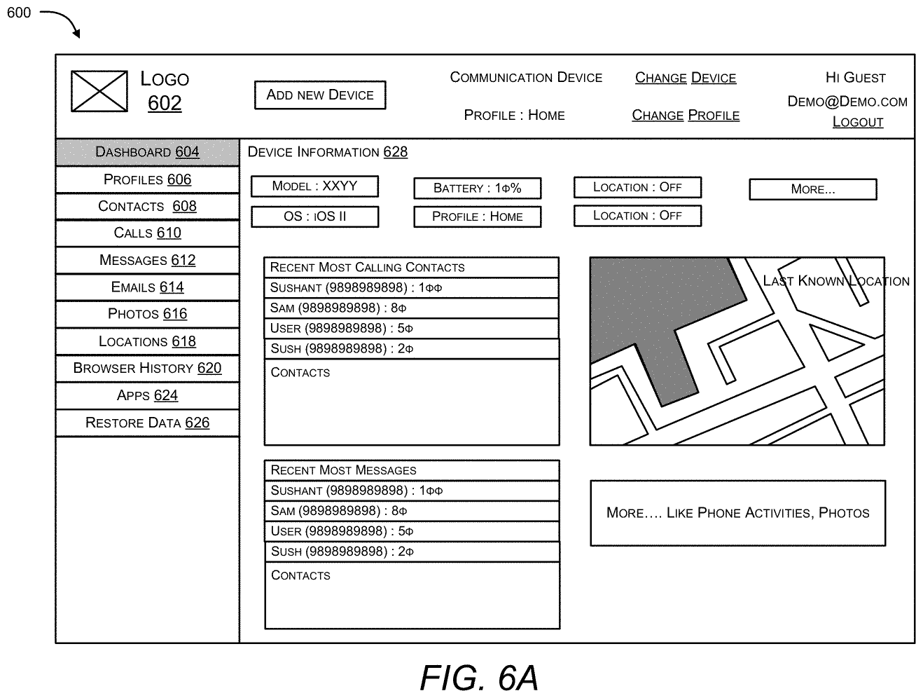

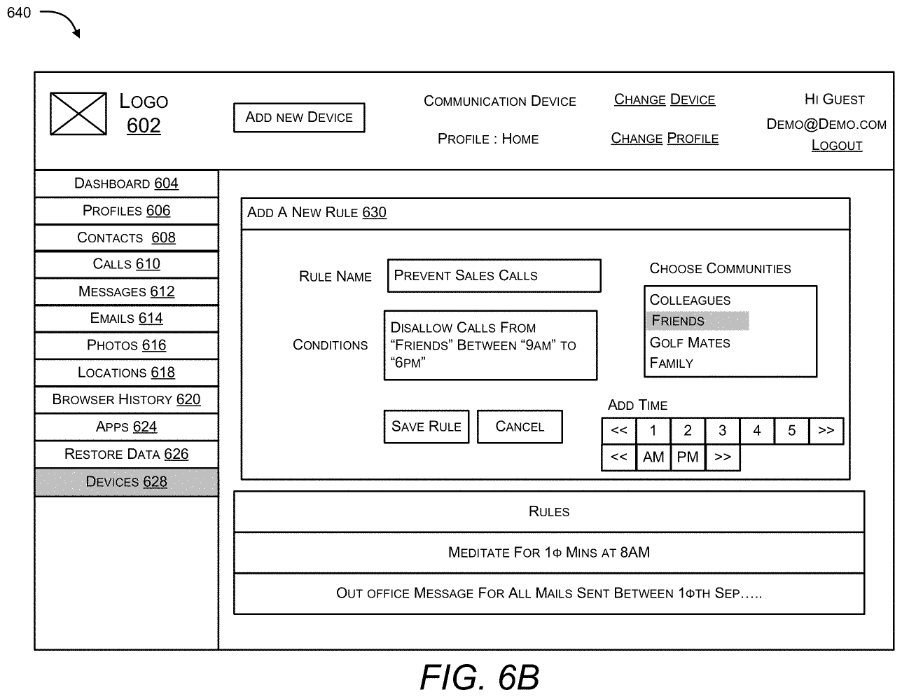

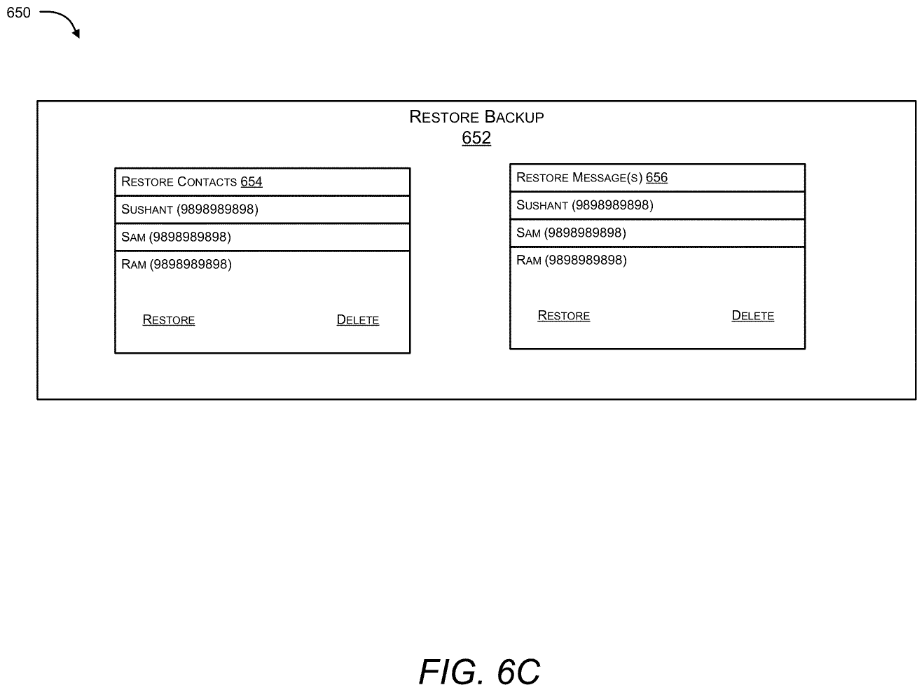

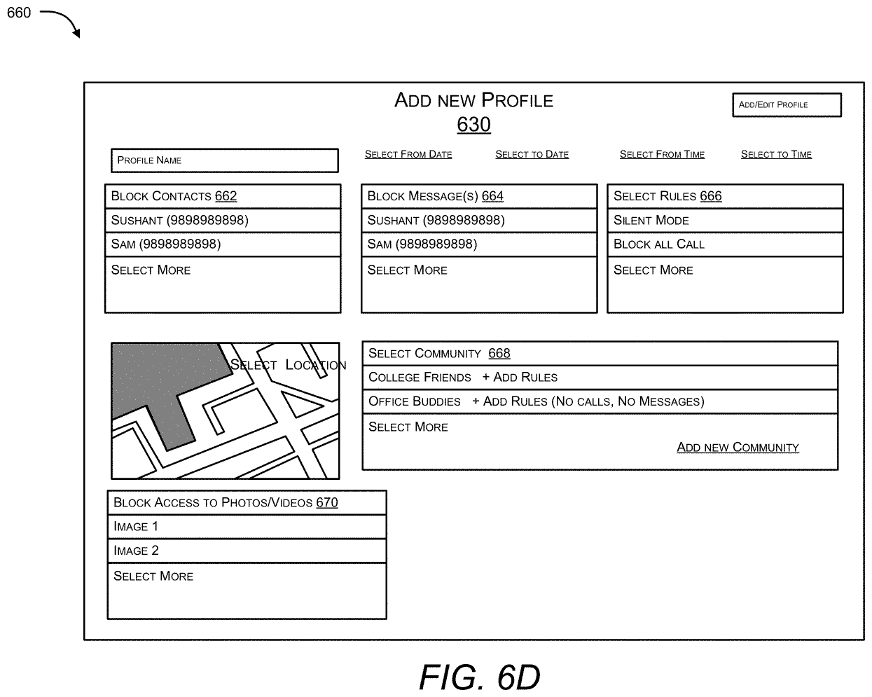

FIG. 6A through 6D illustrates an exemplary overview of a screen upon accessing an account on VFP of FIG. 1, according to an example embodiment of the present disclosure. The VFP account may be accessed by a user by web browsing or via a communication device. In an example embodiment, the users may access by web browsing using valid credentials and two-step authentication. FIG. 6A shows an exemplary overview of a screen 600 showing an actively selected dashboard view 604, according to an example embodiment of the present disclosure. The user can access information pertaining to one or more communication devices having an installed VFD application. The user may have an option to change a communication device and/or access the respective one or more profiles within a communication device by using “change profile” option. The user may also be an option to add a new device. The dashboard may be selected to view profiles pertaining to a single communication device at one time. For a selected communication device, the dashboard may display a logo 602. For a selected communication device, the dashboard 604 may include device tab 628 including, for example, model details, operating system details, location details and other such information. Other details may include an information pertaining to, for example, most called contacts, most messaged contacts, last known location, phone activities, photos and other such details pertaining to a specific communication device and/or a specific profile. The information pertaining to most called/messaged contacts may also indicate the number and/or frequency of calls There may also be an option to logout. The screen 600 may also give access to other alternatives for a selected communication device and a selected profile. The alternatives may include, for example, profiles 606, contacts 608, calls 610, messages 612, emails 614, photos 616, locations 618, browser history 620, applications 624, restore data tab 626 and other such options. The screen 610 may also display information related to, for example, a last known location, phone activities, photos and other such information.

FIG. 6B illustrates an exemplary overview of a screen 640 for receiving or adding the set of desired device parameters on a VFP 102 of FIG. 1, according to an example embodiment of the present disclosure. Upon selecting the device tab 628, the user may add a new rule 630 for a selected communication device and a selected profile by providing the device based parameters. The device based parameters may be added in plain English Text. The device based parameters may vary for the respective one or more profiles in terms of what actions each profile allows a user to perform on the communication device or how the communication device should perform when the respective one or more profiles are invoked. The set of desired device parameters may be associated with at least one of incoming/outgoing calls, incoming/outgoing messages, device settings, media content and settings, and application content and setting. The user may include a rule name and provide parameters or condition such as “disallow calls from friends between “9 am” to “6 pm. The user may include parameters such as the type of community, for example, “friends” for which the parameter/condition may be applied. An option of adding time may also be present. Based on the set of desired device parameters, a plurality of rules are generated by the VFP 102.

FIG. 6C illustrates an exemplary overview of a screen 650 for restoring backup 652 on a VFP 102 of FIG. 1, according to an example embodiment of the present disclosure. Upon selecting restore back up option, the VFP may allow a user to restore messages and contacts that may have been blocked earlier. The options may include, for example, restoring contacts 654 and restoring message 656. There may also be an option to delete a contact permanently. FIG. 6D illustrates an exemplary overview of a screen 660 for adding a new profile 630 on a VFP 102 of FIG. 1, according to an example embodiment of the present disclosure. The screen may display an option, for example, to add a profile name, a range of date, and range of time for which the new profile 630 may be active. The screen 660 may also allow a user, for example, to block contacts 662, block messages 664, block access to photos/videos or media content 670 and select a community or a group of contacts (668). The selection of the community 668 may also be presented along with additional rules already applied for earlier profiles. For example, selection of “no calls, no messages” for a particular group. The user may also be able to add a new community by selecting a list of contacts to be clubbed under one group. The screen 660 may also include “select rules” tab 666 to select one or more existing rules including, for example, “silent mode”, “block all calls” and other such options.

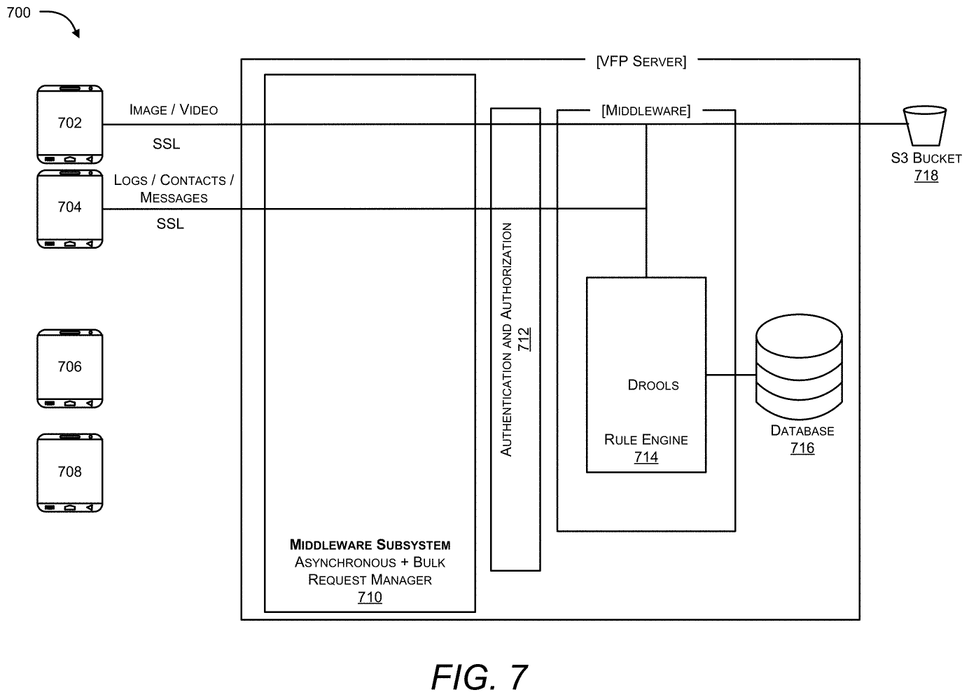

In an example embodiment, the VFP may be operatively coupled with a middleware sub-system to authorize and authenticate one or more sets of desired device parameters received from corresponding one or more VFD engines 106 that are associated with respective communication devices. FIG. 7 illustrates an exemplary overview of an architecture 700 of the VFP 102 of FIG. 1, according to an example embodiment of the present disclosure. The architecture 700 shows multiple communication devices 702, 704, 706 and 708. The communication devices include respective VFD engines 106 that interact with the VFP. The VFP may be operatively coupled with the middleware sub-system including an asynchronous and bulk data manager 710. The asynchronous and bulk data manager 710 may authorize and authenticate one or more sets of desired device parameters received from corresponding one or more VFD engines 106 of the communication devices 702, 704, 706 and 708. The asynchronous and bulk data manager 710 may enable asynchronous data handling mechanism for accepting huge volume requests. The asynchronous and bulk data manager 710 may include Kafka or a similar queue for managing the huge volume requests. The middleware sub-system may be used, for example, for authentication and authorization 712, model management, rule management, profile management, device management, logging and audit purposes, media storage (S3 Buckets) with profile metadata. The authentication and authorization 712 may be for one or more sets of desired device parameters received from the VFD engines 106 of the communication devices 702, 704, 706 and 708. The rule management or processing to obtain the plurality of rules based on set of desired device parameters, for example, logs, contacts, messages to be blocked by a rule engine 714, for example, Drools. The VFP may also include media storage 718, for example, storing images/videos in S3 Buckets with profile metadata. The VFP may also. The VFP may be associated with a VFP server and may include an internal database 716 for backing up data received from the VFD engine 106.

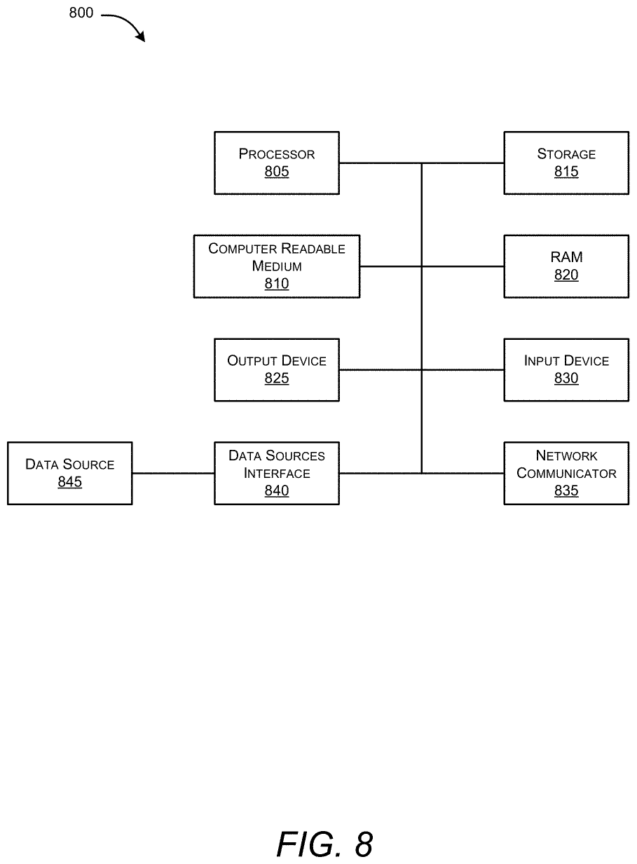

FIG. 8 illustrates a hardware platform 800 for the implementation of the system 100 of FIG. 1, according to an example embodiment of the present disclosure. For the sake of brevity, construction and operational features of the system 100 which are explained in detail above are not explained in detail herein. Particularly, computing machines such as but not limited to internal/external server clusters, quantum computers, desktops, laptops, smartphones, tablets, and wearables which may be used to execute the system 100 or may include the structure of the hardware platform 800. As illustrated, the hardware platform 800 may include additional components not shown, and that some of the components described may be removed and/or modified. For example, a computer system with multiple GPUs may be located on external-cloud platforms including Amazon Web Services, or internal corporate cloud computing clusters, or organizational computing resources, etc.

The hardware platform 800 may be a computer system such as the system 100 that may be used with the embodiments described herein. The computer system may represent a computational platform that includes components that may be in a server or another computer system. The computer system may execute, by the processor 805 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 805 that executes software instructions or code stored on a non-transitory computer-readable storage medium 810 to perform methods of the present disclosure. The software code includes, for example, instructions to gather data and documents and analyze documents. In an example, the VFD engine 106 may be software codes or components performing these steps.

The instructions on the non-transitory computer-readable storage medium 810 are read and stored the instructions in storage 815 or in random access memory (RAM). The storage 815 may provide a space for keeping static data where at least some instructions could be stored for later execution. The stored instructions may be further compiled to generate other representations of the instructions and dynamically stored in the RAM such as RAM 820. The processor 805 may read instructions from the RAM 820 and perform actions as instructed.

The computer system may further include the output device 825 to provide at least some of the results of the execution as output including, but not limited to, visual information to users, such as external agents. The output device 825 may include a display on computing devices and virtual reality glasses. For example, the display may be a mobile phone screen or a laptop screen. GUIs and/or text may be presented as an output on the display screen. The computer system may further include an input device 830 to provide a user or another device with mechanisms for entering data and/or otherwise interact with the computer system. The input device 830 may include, for example, a keyboard, a keypad, a mouse, or a touchscreen. Each of these output device 825 and input device 830 may be joined by one or more additional peripherals. For example, the output device 825 may be used to display the results pertaining to management of calls, messages, media content and devices.

A network communicator 835 may be provided to connect the computer system to a network and in turn to other devices connected to the network including other clients, servers, data stores, and interfaces, for instance. A network communicator 835 may include, for example, a network adapter such as a LAN adapter or a wireless adapter. The computer system may include a data sources interface 840 to access the data source 845. The data source 845 may be an information resource. As an example, a database of exceptions and rules may be provided as the data source 845. Moreover, knowledge repositories and curated data may be other examples of the data source 845.

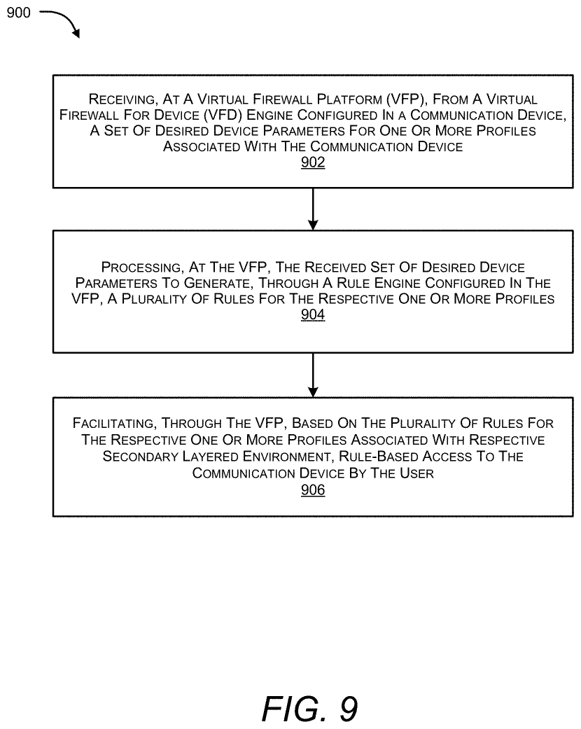

FIG. 9 illustrates a process flowchart illustrating a method 900 for facilitating rule-based control of a communication device, according to an example embodiment of the present disclosure. The order in which method 900 is described is not intended to be construed as a limitation, and any number of the described method blocks may be combined or otherwise performed in any order to implement method 900, or an alternate method. Additionally, individual blocks may be deleted from method 900 without departing from the spirit and scope of the present disclosure described herein. Furthermore, method 900 may be implemented in any suitable hardware, software, firmware, or a combination thereof, that exists in the related art or that is later developed. The method 900 describes, without limitation, the implementation of the system 100. A person of skill in the art will understand that method 900 may be modified appropriately for implementation in various manners without departing from the scope and spirit of the disclosure.

The method 900 may include the step 902 of receiving a set of desired device parameters at a VFP configured in a server. The set of desired device parameters may be received from a VFD engine 106 configured in the communication device. The set of desired device parameters may be for respective one or more profiles associated with the communication device. The set of desired device parameters may vary for the respective one or more profiles in terms of what actions each profile allows a user to perform on the communication device or how the communication device should perform when the respective one or more profiles are invoked. Each profile of the respective one or more profiles may be associated with a respective secondary layered environment. The secondary layered environment may include a different communication enable criteria and a different application criteria. The method may include a step 904 of processing the set of desired device parameters at the VFP. The processing may generate a plurality of rules for the respective one or more profiles through a rule engine configured in the VFP. The plurality of rules may be for the respective one or more profiles and the corresponding secondary layered environment. The plurality of rules may enable the VFD engine 106 to monitor and control at least one of actions performed by the user on the communication device and settings of the communication device. The method may include a step of facilitating 906 rule-based control to the communication device by the user. The rule-based control may be facilitated through the VFP. The rule-based control may be facilitated based on the plurality of rules for the respective one or more profiles associated with respective secondary layered environment.

In an example embodiment, the plurality of rules may be triggered based on any or a combination of time, location, and triggers generated through an AI engine that the VFP is operatively coupled with.

In an example embodiment, the plurality of rules may be applied on at least one of defined contact lists, settings of the communication device, network specific activity, and level of access granted to the user. In an example embodiment, based on the plurality of rules for a selected profile, the level of online access may also vary. For example, a particular profile “A” may be intended to be used by a user but another profile “B” may be intended to be used by a child of the user then the profile “B” may be given access to relatively fewer online websites than the profile “A”. In another embodiment, a particular group of websites may be determined to be blocked for a specific set of profiles. In an example embodiment, a local DNS file that includes host files with a domain and respective IP address may be modified such that the IP address is changed to a localhost for performing the desired activity.

In an example embodiment, at least one of the plurality of rules may be updated by the user of the communication device through the VFD engine 106, based on which, the VFD engine 106 synchronizes with the VFP to control and monitor actions performed on the communication device for the respective one or more profiles.

In an example embodiment, the VFP is operatively coupled with a middleware sub-system to authorize and authenticate one or more sets of desired device parameters received from corresponding one or more VFD engines 106 that are associated with respective communication devices.

In an example embodiment, upon execution of the plurality of rules for a profile selected from the respective one or more profiles by the VFD engine 106 on the communication device, parameters associated with at least one of incoming/outgoing calls, incoming/outgoing messages, device settings, media content and settings, and application content and settings are defined and configured, based on which access is provided and actions are undertaken by the user.

In an example embodiment a communication device comprises a memory to store a primary layered environment and a plurality of secondary layered environments, wherein the plurality of secondary layered environments comprise different communication enabled criteria and different application criteria. The device also includes a processor to receive a selection of a secondary layered environment from the plurality of secondary layered environments, determine communication enabled criteria and application criteria associated with the selected secondary layered environment, determine an enabled communication list associated with the communication enabled criteria for the selected secondary layered environment, determine an active application list associated with the application criteria for the selected secondary layered environment, switch from the primary layered environment to the selected secondary layered environment upon separation of the communication device from a synced accessory by a predetermined distance, receive an incoming communication transmitted to the communication device, determine identification information from the incoming communication, determine if the identification information from the incoming communication is a contact on an enabled communication list for the selected secondary layered environment, wherein the contact on the enabled communication list is copied and pasted or otherwise provided from the primary layered environment to the selected secondary layered environment, if the identification information from the incoming communication is a contact on the enabled communication list, display the incoming communication, if the identification information from the incoming communication is not a contact on the enabled communication list, do not display the incoming communication, and allow communication with applications in the active application list, and a screen to display the selected secondary layered environment.

In alternative example embodiment, a communication device includes a memory to store a plurality of secondary layered environments, wherein the plurality of secondary layered environments comprise different communication enabled criteria and different application criteria. The devices also includes a processor to receive a first selection of the plurality of secondary layered environments stored in the memory, determine communication enabled criteria and application criteria associated with the first selection of the plurality of secondary layered environments, determine an enabled communication list associated with the communication enabled criteria for the first selection of the plurality of secondary layered environments, determine an active application list associated with the application criteria for the first selection of the plurality of secondary layered environments, wherein the the communication device is to switch to the first selection of the plurality the secondary layered environments upon separation of the communication device from a synced accessory by a predetermined distance, at least one of receive and send communications from and to a number of contacts on the enabled communication list, wherein to receive a communication, the communication device is to receive an incoming communication transmitted to the communication device, determine identification information from the incoming communication, determine if the identification information from the incoming communication is a contact on the enabled communication list, wherein the contact on the enabled communication list is copied and pasted or otherwise provided from a primary layered environment to the secondary layered environment of the first selection, if the identification information from the incoming communication is a contact on the enabled communication list, display the incoming communication, if the identification information from the incoming communication is not a contact on the enabled communication list, not display the incoming communication, and communicate with applications in the active application list, and a screen to display the first selection of the plurality the secondary layered environment.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A system for facilitating rule-based control of a communication device, the system comprising:
a processor;
a memory to store a plurality of instructions, which when executed by the processor, cause the processor to:
receive, at a Virtual Firewall Platform (VFP) configured in the system, from a Virtual Firewall for Device (VFD) engine configured in the communication device, a set of desired device parameters for respective one or more profiles associated with the communication device;
wherein the set of desired device parameters vary for the respective one or more profiles in terms of what action each profile allows a user to perform on the communication device or how the communication device should perform when the respective one or more profiles are invoked, and
wherein each profile of the respective one or more profiles is associated with a respective secondary layered environment that has a different communication enable criteria and a different application criteria;
process, at the VFP, the set of desired device parameters to generate, through a rule engine configured in the VFP, a plurality of rules for the respective one or more profiles;
wherein the plurality of rules, for the respective one or more profiles and the respective secondary layered environment, enable the VFD engine to monitor and control at least one of actions performed by the user on the communication device and settings of the communication device; and
facilitate, through the VFP, based on the plurality of rules for the respective one or more profiles associated with respective secondary layered environment, rule-based control to the communication device by the user,
wherein the VFD engine is operatively coupled to a media provider module that provides a media content to an application on the communication device through an Application Programming Interface (API), the media provider module interacts with at least one of an external data source and a database management to obtain the media content, and wherein the external data source pertains to an external communication device.

2. The system as claimed in claim 1, wherein the plurality of rules are triggered based on any or a combination of time, location, and triggers generated through an artificial intelligence (AI) engine that the VFP is operatively coupled with.

3. The system as claimed in claim 1, wherein the plurality of rules are applied on at least one of defined contact lists, settings of the communication device, network specific activity, and level of access granted to the user.

4. The system as claimed in claim 1, wherein at least one of the plurality of rules are updated by the user of the communication device through the VFD engine, based on which, the VFD engine synchronizes with the VFP to control and monitor actions performed on the communication device for the respective one or more profiles.

5. The system as claimed in claim 1, wherein the VFD engine has access to any or a combination of operating system (OS) parameters, messaging parameters, telephony parameters, and local file storage system parameters associated with the communication device.

6. The system as claimed in claim 1, wherein the VFD engine caches, in a local database configured in the communication device, rule attributes associated with the plurality of rules for the respective one or more profiles of the communication device.

7. The system as claimed in claim 1, wherein the VFP is operatively coupled with a middleware sub-system to authorize and authenticate one or more sets of desired device parameters received from corresponding one or more VFD engines that are associated with respective communication devices.

8. The system as claimed in claim 1, wherein, upon execution of the plurality of rules for a profile selected from the respective one or more profiles by the VFD engine on the communication device, parameters associated with at least one of incoming/outgoing calls, incoming/outgoing messages, device settings, media content and settings, and application content and settings are defined and configured, based on which access is provided and actions are undertaken by the user.

9. The system as claimed in claim 1, wherein the user, through the VFD engine, applies a filter for a selected profile of the respective one or more profiles such that the filter allows the selected profile to have relatively more access to the parameters than other profiles of the respective one or more profiles,
wherein the user, through the VFD engine, manages at least one of the media content and the incoming/outgoing messages by tagging, as a private file, at least one of a media file from the media content and a message from the incoming/outgoing messages, wherein after tagging, an access to the private file is restricted by encrypting the private file with a secret key and storing the private file to a pre-determined location in the local database of the VFD engine such that the user accesses the file using the secret key,
wherein the user, through the VFD engine, applies geo fencing for a selected profile from the respective one or more profiles with respect to a pre-determined location such that upon entering the pre-determined location, the selected profile is automatically activated, and
wherein the VFD engine automatically detects a malicious application from a plurality of applications installed on the communication device, wherein the VFD engine pre-determines a category for each application upon installation such that if a specific activity from a plurality of activities performed by each application is not related to the pre-determined category, the VFD engine detects an unusual pattern based on which an alert is flagged and notification is provided to the user, wherein the unusual pattern may comprise at least one of detection of attributes including location detection through a text message or one-time password, detection of attributes including media file in place of a text message, detection of a contact list in place of a media file and detection of a media file in place of a text message.

10. The system as claimed in claim 1, wherein the user comprises any of owner of the communication device or a third party.

11. A communication device comprising:
a memory to store a plurality of instructions;
a VFD engine, which, upon executing the plurality of instructions, causes the VFD engine to:
transmit, to a VFP configured in a server, a set of desired device parameters for respective one or more profiles associated with the communication device, wherein set of the desired device parameters vary for the respective one or more profiles in terms of what actions each profile allows a user to perform on the communication device or how the communication device should perform when the respective one or more profiles are invoked, and wherein each profile of the respective one or more profiles is associated with a respective secondary layered environment that has a different communication enable criteria and a different application criteria;
receive, from the VFP, a plurality of rules for the respective one or more profiles, wherein the plurality of rules are generated by the VFP based on processing of the set of desired device parameters, wherein the plurality of rules, for the respective one or more profiles and secondary layered environment, enable the VFD engine to monitor and control at least one of actions performed by the user on the communication device and settings of the communication device; and
process the plurality of rules for the respective one or more profiles associated with respective secondary layered environment to enable rule-based control to the communication device by the user.

12. The communication device as claimed in claim 11, wherein the plurality of rules are applied on defined contact lists, settings of the communication device, network specific activity, and level of access granted to the user.

13. The communication device as claimed in claim 11, wherein at least one of the plurality of rules are updated by the user of the communication device through the VFD engine, based on which, the VFD engine synchronizes with the VFP to control and monitor actions performed on the communication device for the respective one or more profiles.

14. The communication device as claimed in claim 11, wherein the VFD engine has access to any or a combination of operating system (OS) parameters, messaging parameters, telephony parameters, and local file storage system parameters associated with the communication device.

15. The communication device as claimed in claim 11, wherein, upon execution of the plurality of rules for a profile selected from the respective one or more profiles by the VFD engine on the communication device, parameters associated with incoming/outgoing calls, incoming/outgoing messages, device settings, media content and settings, and application content and settings are defined and configured, based on which access is provided and actions are undertaken by the user.

16. A method for facilitating rule-based control of a communication device, the method comprising:
receiving, at a VFP configured in a server, from a VFD engine configured in the communication device, a set of desired device parameters for respective one or more profiles associated with the communication device, wherein the set of desired device parameters vary for the respective one or more profiles in terms of what actions each profile allows a user to perform on the communication device or how the communication device should perform when the respective one or more profiles are invoked, and wherein each profile of the respective one or more profiles is associated with a respective secondary layered environment that has a different communication enable criteria and a different application criteria;
processing, at the VFP, the set of desired device parameters to generate, through a rule engine configured in the VFP, a plurality of rules for the respective one or more profiles, wherein the plurality of rules, for the respective one or more profiles and secondary layered environment, enable the VFD engine to monitor and control at least one of actions performed by the user on the communication device and settings of the communication device; and
facilitating, through the VFP, based on the plurality of rules for the respective one or more profiles associated with respective secondary layered environment, rule-based control to the communication device by the user.

17. The method as claimed in claim 16, wherein the plurality of rules are triggered based on any or a combination of time, location, and triggers generated through an AI engine that the VFP is operatively coupled with, and wherein the plurality of rules are applied on at least one of defined contact lists, settings of the communication device, network specific activity, and level of access granted to the user.

18. The method as claimed in claim 16, wherein at least one of the plurality of rules are updated by the user of the communication device through the VFD engine, based on which, the VFD engine synchronizes with the VFP to control and monitor actions performed on the communication device for the respective one or more profiles.

19. The method as claimed in claim 16, wherein the VFP is operatively coupled with a middleware sub-system to authorize and authenticate one or more sets of desired device parameters received from corresponding one or more VFD engines that are associated with respective communication devices.

20. The method as claimed in claim 16, wherein, upon execution of the plurality of rules for a profile selected from the respective one or more profiles by the VFD engine on the communication device, parameters associated with at least one of incoming/outgoing calls, incoming/outgoing messages, device settings, media content and settings, and application content and settings are defined and configured, based on which access is provided and actions are undertaken by the user.
